(19) United States
(12) Patent Application Publication
(10) Pub. No.: US 2010/0214375 A1
(43) Pub. Date: Aug. 26, 2010

(54) APPARATUS FOR REFILLING AN INK CARTRIDGE FOR AN INKJET PRINTER

(76) Inventors: Daniel Sulser, Wald (CH); Roland Steiner, Eschenbach (CH); Lucio Bianco, Jona (CH)

Correspondence Address: MICHAEL BEST & FRIEDRICH LLP, 100 E WISCONSIN AVENUE, Suite 3300, MILWAUKEE, WI, 53202, US

(21) Appl. No.: 12/517,438

(22) PCT Filed: Nov. 13, 2007
(86) PCT No.: PCT/EP2007/009808

§ 371 Date: Jul. 21, 2009

(30) Foreign Application Priority Data
Dec. 4, 2006 (DE) 10 2006 057 090.1

(51) Int. Cl. B41J 2/175

(52) U.S. Cl. 347/85

(57) ABSTRACT

An apparatus for refilling an ink cartridge (10 or 13) for an inkjet printer, having a nozzle-comprising print head or having an ink outlet aperture (16) connectible to the ink supply of an inkjet head, either the nozzles of the print head being directly or, in the case of an ink outlet aperture (16) connectible to the ink supply of an inkjet head, said aperture being by way of a wick in fluid connection with an ink reservoir element (17) which is arranged inside the ink cartridge (10 or 13) and which consists of, for example, absorbent material. This apparatus comprises an ink-filled container (11) having an aperture (18) in which there is located a capillary element (wick 20) immersed in the ink (19) and arranged to be brought into contact with the ink reservoir element (17) of the ink cartridge (10 or 13).

### RELATED APPLICATION DATA

This application claims priority from German Patent Application No. 102006057090.1, filed on Dec. 4, 2006 and PCT Application No. PCT/EP2007/009808, filed Nov. 13, 2007, both of which are incorporated by reference herein.

### BACKGROUND

The present invention relates to an apparatus for refilling an ink cartridge for an inkjet printer.

The present case therefore relates to the refilling of an ink cartridge for an inkjet printer with ink, it being necessary to make a distinction between cartridges having integrated print heads on the one hand and cartridges having an ink outlet aperture connectible to the ink supply of an inkjet head. The afore-mentioned print heads comprise a multiplicity of very fine jet nozzles through which the ink is transferred to a print substrate. In the case of cartridges which have an ink outlet aperture connectible to the ink supply of an inkjet head there is usually provided in the aperture a wick which is in fluid connection with an ink reservoir element arranged inside the ink cartridge and consisting of absorbent material.

In the case of cartridges having integrated print heads, the afore-mentioned nozzles are in direct fluid connection with the ink reservoir element arranged inside the cartridge. The ink reservoir element is made either of fiber material or of a foam. As this is a feature known per se, a more detailed description thereof is unnecessary here. Also now available are other “mechanisms that generate negative pressure” which ensure that a metered amount of ink is supplied to the nozzles or to the ink outlet aperture. Because these mechanisms also have a reservoir function, they are likewise to be included hereinbelow under the expression “ink reservoir element”.

In order to be refilled with ink, cartridges having integrated print heads have to be very carefully broken open and re-closed. The effort involved is correspondingly great and is not cost-effective for cartridges having a low capacity.

Furthermore, for cartridges of the afore-mentioned kind, so-called injection refill systems are also known, by means of which an original cartridge can be refilled. The sets in question comprise a drill, a hot glue gun, at least four syringes with transfer tube, ink, a conventional rubber band and closure means. The afore-mentioned systems are commercially available. They are, however, marked by being awkward to handle and by a disproportionately large outlay on materials and tools.

Alternatively, so-called “compatible cartridges” are available which have no electronic components. The electronic components therefore have to be transferred from the empty original cartridge. This too requires skill and tools and also adhesive.

In practice, cartridges having integrated print heads are purchased very expensively on the so-called recycling market. They are then mechanically opened, cleaned and provided with a new ink reservoir element, for example a sponge or the like. The cartridge is then filled with replacement ink and is re-closed. All these operations can in effect only be carried out by a specialist refill company, that is to say not by the user himself.

### SUMMARY

The present invention is accordingly based on the problem of making available an apparatus for refilling an ink cartridge for an inkjet printer, which apparatus is simple to manufacture and, especially, simple to use, so that it can be readily mastered by the end consumer. Also, it should be equally effective for cartridges having integrated print heads and for cartridges having an ink outlet aperture connectible to the ink supply of an inkjet head.

The core of the present invention lies in a so-called “capillary refill system”. The capillary suction power of the ink cartridge to be filled is utilized for the purpose of filling. The system has an ink container of usually flat form, with adequately high standing stability, containing a wick immersed in ink. The wick leads out from the container at the upper face thereof and is so arranged that, when the ink cartridge is set in place thereon, a capillary connection is formed therewith, that is to say either with the nozzles of the integrated print head or with the ink outlet aperture connectible to the ink supply of an inkjet head. The container preferably also has a venting or pressure equalization aperture so that the ink cartridge set in place thereon can take up ink by capillary action unhindered. This aperture can at the same time serve for filling the ink container.

In accordance with the invention, the ink reservoir element of the ink cartridge can be refilled with a portion of ink in simple manner, more particularly without using tools and within a few minutes. There is also no risk of ink soiling the user.

With the apparatus according to the invention, portions of ink of different colors can accordingly be made commercially available. The article is a disposable article. OEM cartridges can be filled a number of times using the apparatus according to the invention. Filling can also be carried out by way of the nozzles of integrated print heads even if this possibly takes slightly longer than filling a cartridge having a wick in the ink outlet aperture.

No additional pressure is required for filling the ink cartridge. The ink reservoir element located in the cartridge, for example sponge or fiber material or the like, absorbs ink until saturated. It is therefore also not possible to overfill the cartridge. As already mentioned, the apparatus according to the invention is also so constructed that contact with open ink does not come about so that a corresponding risk of the user or surroundings being soiled is avoided. Also, using the apparatus according to the invention, an ink cartridge can be refilled substantially more quickly than, for example, by means of a syringe where the cartridge first has to be drilled open before it can be refilled. After refilling, the drilled hole in question has to be re-closed. All those operations take longer and also require a degree of skill that is not inconsiderable. In addition, special tools are required. All those disadvantages are avoided by the apparatus according to the invention. The size of the portions of ink is such that no residual ink is left over in the ink container according to the invention.

Tests have shown that the ink reservoir element of the ink cartridge is completely replenished after an absorption time of about 2.5 up to max. 5.0 minutes. This means that after that time period the ink reservoir element is saturated.

The previously mentioned pressure equalization aperture, which also serves for filling of the ink container according to the invention, is so dimensioned that the external blocking pressure is always greater than the emptying pressure so that no ink can run out of the container through the mentioned aperture. The same also applies to the wick of the apparatus according to the invention.

The mentioned wick of the ink container is so constructed, dimensioned and arranged that it can be brought into contact by simple means either with the nozzles provided in the print head of the ink cartridge or with a wick arranged in the ink outlet aperture of the ink cartridge, in the latter case the wick of the ink container being made of softer or more yielding material than the wick of the ink cartridge so that the wick of the ink cartridge is not deformed by the contact with the wick of the ink container. This is important in order to also ensure the fluid connection between the ink cartridge and the ink supply of an inkjet head after refilling of the cartridge.

In a preferred embodiment, the wick of the ink container extends through the base of a trough-like depression on the upper face of the ink container. This trough-like depression serves the purpose of collecting any ink that may possibly come out of the wick of the ink container or out of the ink cartridge after the latter has been refilled. To that extent, the trough-like depression represents an additional safeguard against soiling.

A particular embodiment is furthermore distinguished by the fact that on the upper face of the ink container there is provided at least one groove-shaped receiving opening for an ink cartridge, in which an ink cartridge can be so placed, especially held by clamping, that either the nozzles in the integrated print head of the cartridge or, alternatively, the wick in the ink outlet aperture come(s) into contact with the wick of the ink container so as to form a capillary connection.

For that purpose, the at least one receiving groove has a stop for positioning the ink cartridge to be refilled. Preference is given to an end face of the ink cartridge to be refilled co-operating with that stop.

Preference is given to there being provided on the upper face of the ink container at least two receiving grooves, especially extending crosswise to one another, for ink cartridges of different widths. Accordingly, of course, the receiving grooves themselves are also of different widths.

As already mentioned, preference is given to there being located on the upper face of the ink container an ink-filling aperture, which at the same time serves as a venting or pressure equalization aperture.

Furthermore, it should again be pointed out that the ink container has a standing surface which is so dimensioned that, even with an ink cartridge connected up and extending out beyond the peripheral edge of the ink container, adequate standing stability is ensured. Accordingly, the ink container according to the invention is of flat and wide construction. Preference is given to the ink container having a truncated conical, truncated pyramidal or spherical-cap-shaped basic shape with a circular or rectangular base.

For the purpose of complete emptying of the ink container, the wick thereof extends as far as the base and is arranged within a fluid-permeable cage, which preferably also extends as far as the base of the ink container. This cage can comprise at least three vertical bars arranged evenly distributed over the circumference, especially integrally connected to the ink container or the upper face thereof.

It is also advantageous for complete emptying of the ink container if the base of the ink container becomes lower in the direction of that end of the wick which is associated with the base.

Before use, the wick of the ink container and its ink-filling and pressure equalization aperture are sealed by means of an adhesive strip which can be pulled off. This adhesive strip or a similar strip can then also be used again for closing the ink container before disposal thereof. The mentioned adhesive strip is preferably arranged to be placed within a receiving groove, especially the wider receiving groove, for an ink cartridge, so that on the side facing the ink-filling and pressure equalization aperture it projects beyond the free edge of the receiving groove to form a gripping tab. As a result it is ensured that, when the adhesive strip is pulled off before the apparatus according to the invention is first put to use, the trough-like depression, within which the wick extends, is first opened and then the ink-filling and pressure equalization aperture, before the wick is exposed. Accordingly, when first being put to use, there is first carried out venting or pressure equalization by way of the ink container wick projecting into the trough-like depression so that there is no risk, because of an excessive overpressure within the container, of ink unintentionally seeping out or even downright spurting out from the ink container by way of the venting aperture when the adhesive strip is pulled off. Such an overpressure can form, for example, if the surroundings are relatively hot. According to the invention, therefore, it is always ensured that first of all pressure equalization is brought about between the interior of the ink container and the external surroundings so that the aforementioned risk is precluded.

Finally, it is advantageous for the ink container to be made at least in part, preferably entirely, of transparent material, such as plastic materials, so that the user will see whether the ink container still contains any ink and what the color of the ink is.

An especially simple alternative arrangement is distinguished by the fact that the apparatus for refilling an ink cartridge has an ink-filled container having an aperture through which the ink reservoir element by means of the nozzles of the print head or the ink outlet aperture of the ink cartridge is arranged to be brought directly into contact. In this arrangement, therefore, the capillary element in the container aperture, which especially is in the form a wick, is omitted. The apparatus consequently becomes even simpler, without the functionality suffering as a result.

In order to reduce or avoid the risk of soiling, it is advantageous if the aperture of the container is provided on the upper face of the latter and has a cross-section corresponding to the outer contour of the nozzle-comprising print head or the ink outlet aperture of the ink cartridge and, preferably, the container aperture is also bounded by a sealing strip, especially of elastomer or rubber. The sealing strip is then preferably so dimensioned that it abuts the print head or ink outlet aperture of the ink cartridge in fluid-tight manner when the latter is in the docked position.

It is moreover advantageous for complete emptying of the ink container if the receiving grooves for the ink cartridge are so provided on the upper face of the ink container that the nozzles of the print head or the ink outlet aperture of the ink cartridge extend as far as the base of the ink container when the cartridge is docked. Ultimately this is dependent on the length of the nozzle-comprising print head or of the channel bounding the ink outlet aperture. The ink container and ink cartridge should therefore be so matched to one another that complete emptying of the ink container is possible when the ink cartridge is docked.

Before being used for the first time, the container aperture must of course be closed or covered. For this purpose, the container aperture, by way of which the fluid contact with the ink reservoir element of the ink cartridge is arranged to be established, is sealable, preferably by means of a film, especially a strip of film. Before being used for the first time, this strip of film is then pulled off After being used, the container aperture can be re-closed by another strip of film, for example a Tesa® strip. It is also feasible for the strip of film to be held by means of a cold adhesive which can be stuck back, so that the container aperture can be re-closed using the original strip of film.

In the last-mentioned embodiment there is also preferably provided in the ink container a separate venting or pressure equalization aperture, which in the case of an advantageous embodiment is arranged within a container depression. This venting or pressure equalization aperture also must be closed before being used for the first time. For that purpose there is also preferably used a strip of film, especially the same strip of film with which the aperture for docking of the ink cartridge is sealable.

A preferred embodiment of an apparatus constructed in accordance with the invention is explained hereinbelow in greater detail with reference to the accompanying drawings.

### BRIEF DESCRIPTION OF THE DRAWINGS

FIG. 1 is a perspective view from above of a first embodiment of an apparatus according to the invention for refilling an ink cartridge;

FIG. 2 is a cross-section through the apparatus according to FIG. 1 along line II-II in FIG. 1;

FIG. 3 is a perspective view from below of the upper part of the ink container of the apparatus according to FIG. 1;

FIG. 4 is a side view of the ink container according to FIG. 1 with an ink cartridge set in place thereon;

FIG. 5 is a top view of the apparatus according to FIG. 1 showing the connecting up of two ink cartridges of different widths;

FIG. 6 is a perspective oblique view from above of a modified embodiment of an apparatus according to FIG. 1;

FIG. 7 is a perspective oblique view from above of a further modified embodiment of the apparatus according to FIG. 1;

FIG. 8 is a perspective oblique view from above of an embodiment according to FIG. 1 with a closing lid; and

FIG. 9 is a perspective view from below of the closing lid according to FIG. 8 to an enlarged scale.

### DETAILED DESCRIPTION

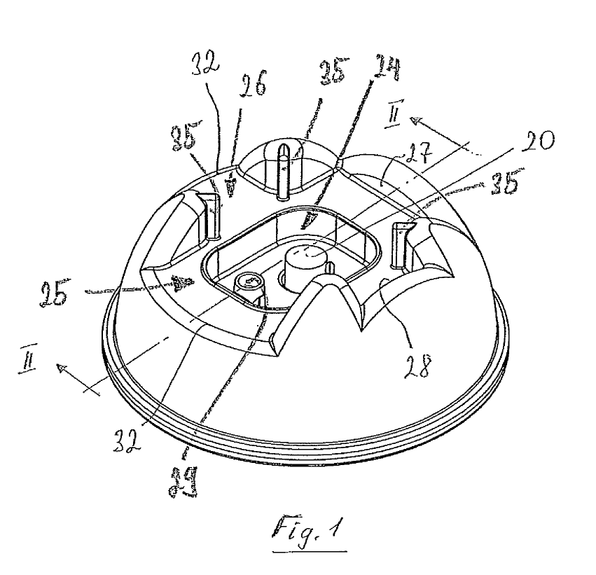

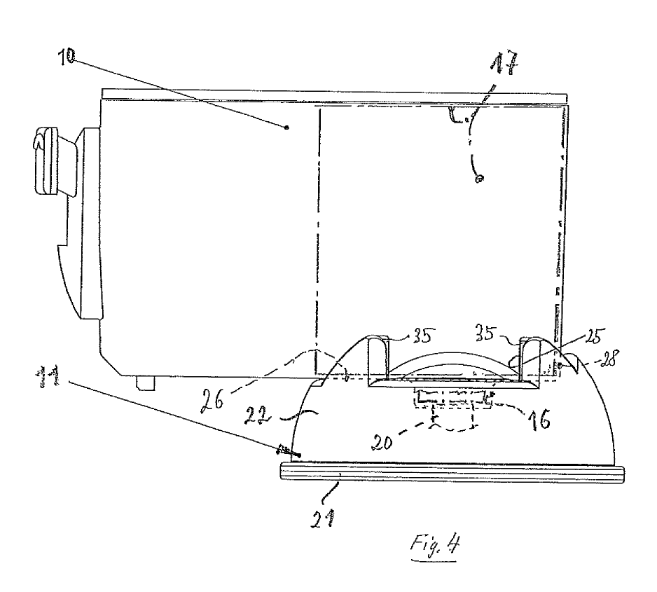

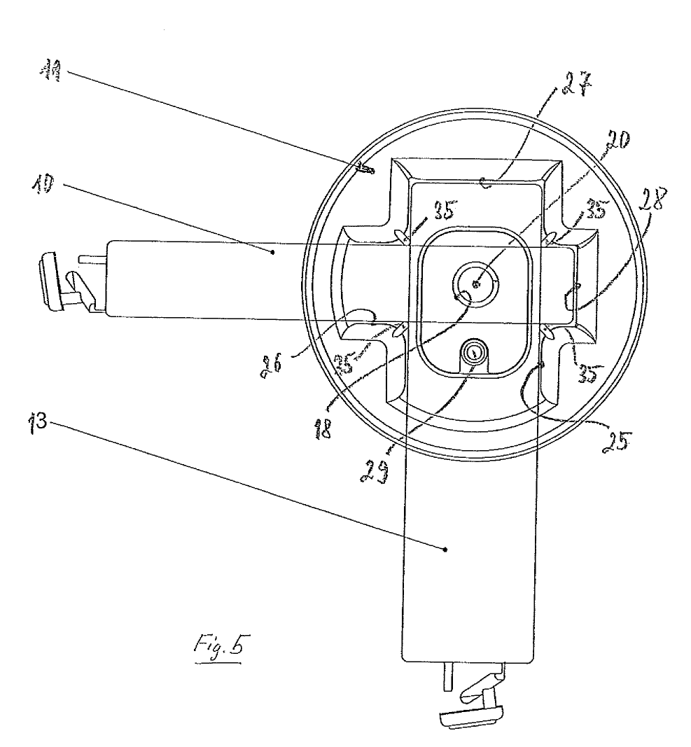

The first embodiment according to FIGS. 1 to 5 is an apparatus for refilling an ink cartridge 10 or 13 (see FIG. 5) for an inkjet printer, having an ink outlet aperture 16 connectible to the ink supply of an inkjet head, which aperture is in fluid connection, by way of a wick not shown here in greater detail, with an ink reservoir element 17 arranged inside the ink cartridge 10 and consisting of absorbent material. The apparatus includes an ink-filled container 11 having an aperture 18 in which there is located a capillary element, in the form of a wick 20, immersed in the ink 19 and arranged to be brought into contact with the ink reservoir element 17 of the ink cartridge 10. The wick 20 is made in customary manner of fiber material having high capillary action in the longitudinal direction of the wick. For refilling an ink cartridge, this wick 20 is, in the embodiment shown, arranged to be brought into contact with the wick arranged in the ink outlet aperture 16 of the ink cartridge 10. The wick 20 of the ink container 11 is made of softer or more yielding material than the wick of the ink cartridge 10 so that the wick of the ink cartridge 10 remains substantially undeformed by the contact with the wick 20 of the ink container 11. The contact between the two afore-mentioned wicks of the ink container 11 and the ink cartridge 10 is indicated in FIG. 4.

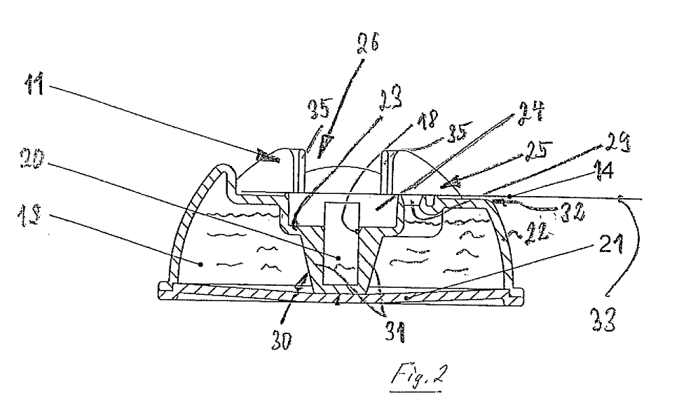

The ink container 11 of the embodiment according to FIGS. 1 to 5 includes a circular base 21 and a spherical-cap-shaped upper part 22. The wick 20 of the ink container 11 extends through the base 23 of a trough-like depression 24 on the upper face of the ink container 11, more particularly into the trough-like depression 24, as can be seen very well from FIG. 2. On the upper face of the ink container 11 there are provided two groove-shaped receiving openings 25, 26 extending crosswise to one another for ink cartridges 10 and 13 of different widths (see FIG. 5). The correspondingly wide ink cartridge 10 or 13 can be so placed, especially held by clamping, within those receiving openings 25, 26 that the wick in the ink outlet aperture 16 of the ink cartridge comes into contact with the wick 20 of the ink container 11 so as to form a capillary connection.

Each of the two receiving grooves 25, 26 has a stop 27, 28 for positioning the ink cartridge 13 and 10, respectively, to be refilled.

Within the trough-like depression 24 on the upper face of the ink container 11 there is also provided an ink-filling aperture 29, which at the same time serves as a venting or pressure equalization aperture. The way in which this aperture functions has already been described hereinbefore.

The base 21 of the ink container 11 defines a standing surface which, in accordance with FIGS. 4 and 5, is so dimensioned that, even in the case of an ink cartridge 10 or 13 which has been connected up and which then extends out beyond the peripheral edge of the ink container 11, adequate standing stability is ensured.

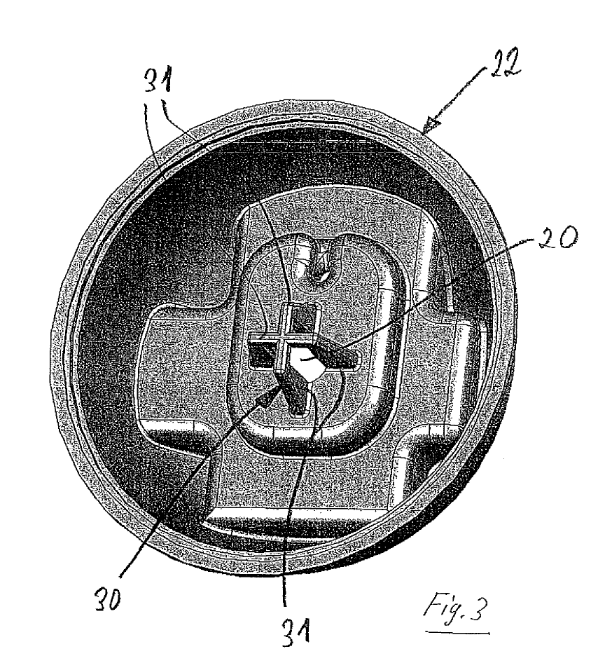

As can be seen especially from FIG. 2, but also from FIG. 3, the wick 20 of the ink container 11 is so constructed that it extends as far as the base of the container 11. It is held in that position within a fluid-permeable cage 30 which preferably also extends as far as the base of the ink container. In the embodiment shown, the cage 30 for the wick 20 has 4 vertical bars 31 which are arranged evenly distributed over the circumference and integrally connected to the upper part 22 of the ink container 11 and which hold the wick 20 centered within the aperture 18.

In accordance with FIG. 2, the base 21 of the ink container 11 becomes lower in the direction of that end of the wick 20 which is associated with the base. This ensures exhaustive emptying of the container 11.

It can furthermore be seen from FIG. 2 that the wick 20 of the ink container 11 and its ink-filling or pressure equalization aperture 29 are sealable by means of an adhesive strip 14 which can be pulled off. The adhesive strip 14 can be placed within a receiving groove, in this case the wider receiving groove 25, for an ink cartridge (in this case ink cartridge 13 according to FIG. 5), more particularly so that on the side facing the ink-filling or pressure equalization aperture 29 it projects beyond the free edge 32 of the receiving groove 25 to form a gripping tab 33, so that, when the adhesive strip 14 is pulled off, first the trough-like depression 24 and, with it, by way of the wick extending into it, the interior of the ink container are vented, before the venting or pressure equalization aperture 29 is exposed. This ensures that, before being used for the first time, any potential overpressure within the container 11 is relieved. After use, the trough-like depression 24 and the aperture 29 can be re-closed with the adhesive strip 14 or another adhesive strip, for example Tesa® film. This ensures that soiling is prevented before the described apparatus is disposed of, i.e. after its use.

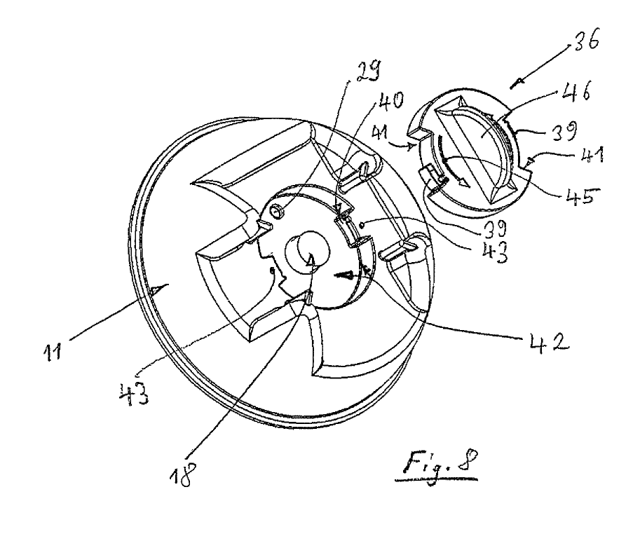

The embodiment according to FIG. 7 is distinguished from that according to FIGS. 1 to 5 by the fact that the container 11 has a truncated conical basic structure.

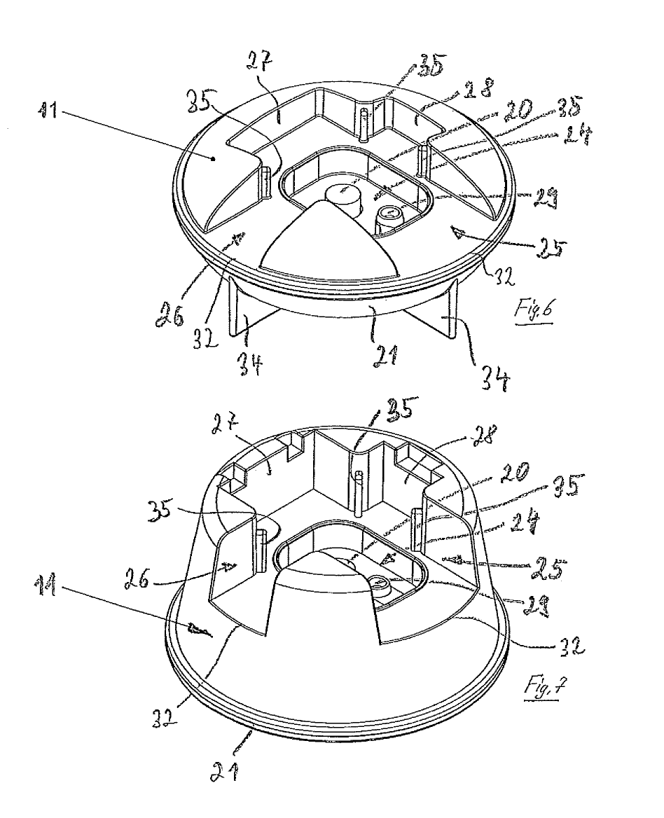

The embodiment according to FIG. 6 has a lenticular basic structure. Accordingly, the base 21 is also dish-shaped. In order to ensure standing stability, at least three ribs arranged evenly over the circumference are formed onto the base 21, the horizontal bottom edges of which ribs define the standing surface.

Otherwise, features already described with reference to FIGS. 1 to 5 are identified by the same reference numerals in FIGS. 6 and 7.

Referring to FIG. 7, the ink container 11 also includes vertical clamping ribs 35 at the four internal bounding corners between the receiving grooves 25, 26 that cross one another for the ink cartridges 10 and 13 of different widths. These clamping ribs 35, which extend diagonally relative to the wick 20, serve for firmly clamping the ink cartridges 10, 13 in the associated receiving grooves. These clamping ribs 35 also compensate for minor tolerances in respect of the width of the ink cartridges used. The ink cartridges 10 and 13 are accordingly positioned between, on the one hand, the clamping ribs 35 and, on the other hand, the respective stops 27, 28, more particularly in precise association with the wick 20 of the ink container 11.

It should also be pointed out again at this juncture that it is also possible to refill ink cartridges having an integrated print head, more particularly through the nozzles associated with the print head, which nozzles are in direct fluid connection with the ink reservoir element(s) inside the ink cartridge. In this case, the mentioned nozzles directly abut the free end face of the wick 20. The nozzles themselves act as capillary channels.

As already mentioned hereinbefore, the ink container 11 is preferably made of transparent material, especially such as plastic materials. In this case, it can be established very well whether the ink container 11 is still filled with ink and, if so, what the color of the ink is.

It should furthermore be mentioned that the ink container 11 consists of two parts, namely the housing upper part 22 and the base 21. These two parts are welded together before filling, more particularly at the edges.

FIG. 8 shows an embodiment modified with respect to the Figures described hereinbefore in such a way that the aperture 18, by way of which the ink reservoir element 17 of the ink cartridge 13 is arranged to be brought into fluid connection with the ink in the container 11 in the manner described hereinbefore, is arranged to be closed by means of a lid, in this case a screw lid 36. The screw lid 36 has, on its periphery, twist lock elements 39, which engage in groove elements 40 on the container to form a bayonet closure. The twist lock elements are formed on the outer periphery of the lid 36 diametrically relative to the mid-axis thereof, more particularly within depressions 41 in the rim. The complementary groove elements 40 are formed within a pot-like recess 42 formed on the upper face of the container 11 for the lid 36, specifically within projections 43 extending radially into the pot-like recess 42. After the container 11 has been filled through the aperture 29, the lid 36 is placed in the recess 42, more particularly in such a way that the projections 43 on the container enter the depressions 41 on the lid 36. The lid 36 is then turned in the clockwise direction so that the twist lock elements 39 engage in the grooves 40 and hold the lid 36 in the closed position.

By that means, the aperture 18 is closed, and also the filling and venting aperture 29 located at the base of the recess 42.

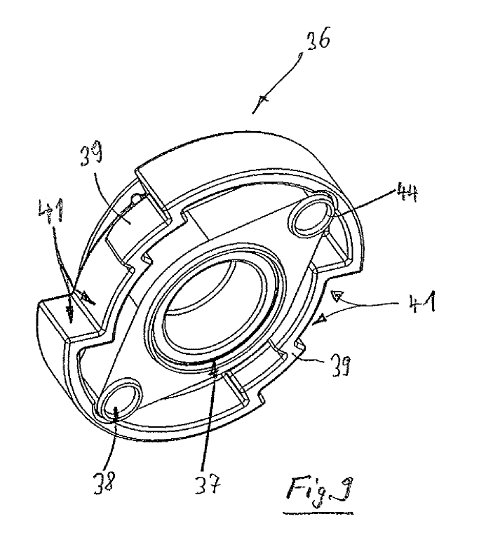

On the underside of the lid 36, in accordance with FIG. 9, there are formed or arranged sealing elements 37, 38, which are made of flexibly resilient, especially elastomeric, material. These sealing elements are associated, on the one hand, with the aperture 18 and, on the other hand, with the aperture 29. In specific terms, the afore-mentioned sealing elements comprise sealing lips which in each case surround the container aperture 18 and the venting aperture 29 in the manner of a ring. At least those sealing lips are made from the aforementioned flexibly resilient material.

Opposite the sealing element 38 (more particularly opposite relative to the mid-axis of the central sealing element 37), there is also arranged an element 44 corresponding to the sealing element 38 but serving merely as a supporting element so that the lid does not take up a skew position within the recess 42 when in the closed position. The supporting element 44, which in the embodiment shown is of exactly the same construction as the sealing element 38, holds the lid 36 horizontally within the recess 42 in the closed position so that, when the lid 36 is in the closed position, the sealing element 38, or the annular sealing lip defining the sealing element 38, surrounds the venting aperture 29 in fluid-tight manner, that is to say without tilting relative to the venting aperture 29. The supporting element 44 can of course be differently constructed, for example as a nipple-like projection or the like. It has merely a supporting function, not a sealing function.

The illustrations in FIGS. 8 and 9 show very clearly that the mid-axis of the container aperture 18 is aligned with the mid-axis of the lid 36 when the latter is in the closed position so that, on turning of the lid 36 away from the closed position, that is to say in the direction of the arrow 45, first the venting aperture 29 is opened, before the lid then becomes fully removable or demountable when turned further in that direction. By this means ink is reliably prevented from unintentionally spurting out of the venting aperture 29 to the extent that the user is soiled or the surface on which the container 11 is standing is soiled. The lid holds back ink which might unintentionally spurt out through the aperture 29. Ink that does unintentionally come out through the aperture 29 always remains within the recess 42 on the upper face of the container 11.

In terms of handling, the embodiment according to FIGS. 8 and 9 is therefore extremely clean and functional.

As FIG. 8 also shows, a projecting tab 46 is also arranged, especially formed, on the upper face of the lid 36 as a handle for turning the lid into the closed or open position.

1.-29. (canceled)

30. An apparatus for refilling an ink cartridge for an inkjet printer, the ink cartridge having one of a nozzle associated with a print head to form an integrated print head ink cartridge and an ink outlet aperture connectible to an ink supply of an inkjet head, the ink outlet aperture having a wick arranged in the ink outlet aperture, the ink cartridge further including an ink reservoir element arranged inside the ink cartridge and the ink reservoir element including one of an absorbent material and a mechanism that generates negative pressure, the ink reservoir element in fluid communication with one of the nozzle and the ink outlet aperture by way of the wick, the apparatus for refilling the ink cartridge comprising:
an ink-filled container having an aperture in which is located a capillary element immersed in ink and configured to be brought into contact with the ink reservoir element of the ink cartridge.

31. The apparatus of claim 30, wherein the capillary element includes a wick.

32. The apparatus of claim 31, wherein the ink-filled container is arranged to be brought into contact with one of the nozzle associated the print head and with the wick arranged in the ink outlet aperture of the ink cartridge.

33. The apparatus of claim 32, wherein the wick of the ink-filled container is made of a more yielding material than the wick of the ink cartridge so that the wick of the ink cartridge remains substantially undeformed by the contact with the wick of the ink-filled container.

34. The apparatus of claim 31, wherein the wick of the ink-filled container is configured to extend through a base of a trough-like depression on an upper face of the ink-filled container.

35. The apparatus of claim 34, wherein the upper face of the ink-filled container includes at least one groove-shaped receiving opening in which the ink cartridge can be placed, and wherein the ink-filled container includes clamping ribs to couple the ink cartridge to the ink-filled container at least partially within the at least one grooved-shaped receiving opening such that either the nozzle of the ink cartridge or the wick arranged in the ink outlet aperture of the ink cartridge comes into contact with the wick of the ink-filled container so as to form a capillary connection.

36. The apparatus of claim 35, wherein the at least one groove-shaped receiving opening has a stop for positioning the ink cartridge to be refilled.

37. The apparatus of claim 35, wherein the upper face of the ink-filled container includes at least two groove-shaped receiving apertures each having a different width, and wherein the at least two groove-shaped receiving apertures extend crosswise to one another and are configured to receive ink cartridges having different widths.

38. The apparatus of claim 34, wherein the upper face of the ink-filled container includes an ink-filling aperture, which also is configured to be a venting equalization aperture.

39. The apparatus of claim 30, wherein the ink-filled container has a standing surface which is configured such that with an ink cartridge connected to and extending out beyond a peripheral edge of the ink-filled container, the ink-filled container can stand on the standing surface.

40. The apparatus of claim 30, wherein the wick of the ink-filled container is configured to extend as far as a base of the ink-filled container, wherein the wick of the ink-filled container is arranged within a fluid-permeable cage, and wherein the fluid-permeable cage is configured to extend as far as the base of the ink-filled container.

41. The apparatus of claim 40, wherein the fluid-permeable cage includes at least three vertical bars evenly distributed around the circumference of the cage, wherein the at least three vertical bars are integrally connected to the ink-filled container.

42. The apparatus of claim 31, wherein a base of the ink-filled container becomes lower in a direction of an end of the wick of the ink-filled container that is associated with the base.

43. The apparatus of claim 31, wherein the ink-filled container includes an ink-filling and pressure equalization aperture, wherein the ink-filled container includes a removable adhesive strip configured to be pulled off of the ink-filled container, and wherein the adhesive strip is configured to seal the wick of the ink-filled container and the ink-filling and pressure equalization aperture.

44. The apparatus of claim 43, wherein the ink-filled container includes at least one groove-shaped receiving opening in which the ink cartridge can be so placed such that either the nozzle of the ink cartridge or the wick arranged in the ink outlet aperture of the ink cartridge comes into contact with the wick of the ink-filled container so as to form a capillary connection, wherein the at least one groove-shaped receiving opening is configured to receive the adhesive strip such that the adhesive strip projects beyond a free edge of the at least one groove-shaped receiving opening to form a gripping tab.

45. The apparatus of claim 30, wherein the ink-filled container is made at least in part of a transparent material.

46. The apparatus of claim 30, wherein the ink-filled container has one of a truncated conical, a truncated pyramidal, a lenticular and spherical-cap-shaped basic shape and one of a circular and rectangular base.

47. The apparatus of claim 30, wherein either the nozzle associated with the print head or the ink outlet aperture of the ink-filled cartridge is configured to be brought directly into contact with the aperture of the ink-filled container.

48. The apparatus of claim 47, wherein the aperture of the ink-filled container is provided on an upper face of the ink-filled container and the aperture has a cross-section configured to correspond to the outer contour of either the nozzle associated with the print head or the ink outlet aperture of the ink cartridge.

49. The apparatus of claim 48, wherein the aperture is bounded by a sealing strip formed from one of an elastomer and rubber, the sealing strip configured to abut either the nozzle associated with the print head or the ink outlet aperture of the ink cartridge in fluid-tight manner when the ink cartridge is in a docked position.

50. The apparatus of claim 49, wherein the ink-filled container includes a strip of film, and wherein the aperture is configured to be sealed by the strip of film.

51. The apparatus of claim 50, wherein the ink-filled container includes a pressure equalization aperture arranged within a depression of the ink-filled container, the pressure equalization aperture configured to be sealed by the strip of film.

52. The apparatus of claim 35, wherein the at least one groove-shaped receiving opening for the ink-filled cartridge is provided on the upper face of the ink-filled container such that either the nozzle associated with the print head or the ink outlet aperture of the ink cartridge extends as far as a base of the ink-filled container when the ink cartridge is docked to the ink-filled container.

53. The apparatus of claim 30, further comprising a screw lid, wherein the aperture of the ink-filled container is configured to be closed by the screw lid.

54. The apparatus of claim 53, wherein the ink-filled container includes a venting aperture, wherein the screw lid is configured to also serve as a closure for the venting aperture.

55. The apparatus of claim 54, wherein an underside of the lid that faces the ink-filled container includes a plurality of arranged sealing elements which are so associated with the aperture of the ink-filled container and with the venting aperture that the plurality of arranged sealing elements close the aperture of the ink-filled container and the venting aperture when the lid is in a closed position.

56. The apparatus of claim 55, wherein the plurality of arranged sealing elements are formed by sealing lips which surround the aperture of the ink-filled container and the venting aperture in the manner of a ring, and which are made of relatively resilient elastomeric material.

57. The apparatus of claim 54, wherein when the screw lid is in a closed position, a mid-axis of the aperture of the ink-filled container is aligned with a mid-axis of the lid so that, on turning of the screw lid away from the closed position, the venting aperture is opened first, before the screw lid becomes fully removable from the ink-filled container.

58. The apparatus of claim 53, wherein the screw lid is arranged to be locked to the ink-filled container by complementary bayonet closure elements of the screw lid and the ink-filled container.

59. The apparatus of claim 53, wherein the screw lid is arranged to be placed within a complementary recess in the ink-filled container.
